(19) United States
(12) Patent Application Publication
(10) Pub. No.: US 2013/0307704 A1
(43) Pub. Date: Nov. 21, 2013

(54) PARKING RESTRICTION INFORMATION

(71) Applicants: Chris Morales, Hawthorne, CA (US); Harry Tarnoff, Los Angeles, CA (US)

(72) Inventors: Chris Morales, Hawthorne, CA (US); Harry Tarnoff, Los Angeles, CA (US)

(21) Appl. No.: 13/868,670

(22) Filed: Apr. 23, 2013

Related U.S. Application Data
(60) Provisional application No. 61/647,924, filed on May 16, 2012.

(51) Int. Cl. G08G 1/14

(52) U.S. Cl. CPC G08G 1/149
USPC 340/932.2

(57) ABSTRACT

Parking restrictions are provided by an app and generates a display, which can be on the screen of a mobile smartphone, a tablet, a computer, or on a handheld or vehicle built-in navigation system screen. The app can obtain parking restrictions for current location from a database that is updated either from a centralized service or by user input. The provided parking restriction information can be used to set reminder alarms when the driver decides to park.

### CROSS-REFERENCE TO RELATED APPLICATIONS

This application claims the benefit of Provisional Patent Application No. 61/647,924, filed May 16, 2012.

### FIELD OF THE INVENTION

The invention relates to the field of vehicle parking and, more particularly, to a method for assisting drivers to honor posted parking rules.

### BACKGROUND OF THE INVENTION

Various methods have been proposed relating to parking problems faced by automobile drivers. U.S. Patent Publication No. 2011/0140927 describes a method for providing a warning message to a driver of a parked vehicle that the vehicle is in violation of parking restrictions, which uses an informant who observes illegally parked vehicles. U.S. Pat. No. 6,133,855 describes a method for warning illegal stopping and warning a car by comparing position information of a vehicle provided by a global positioning system receiver with position information of banned areas stored in a data storage to discriminate whether the vehicle is parked or stopped according to an engine revolution and a vehicle speed detected while the vehicle is within a banned area, raising a warning when the vehicle is parked or stopped as a result of the discrimination. U.S. Patent Publication No. 2004/0133464 describes a parking system having an information processing center for receiving transaction and alarm information from payment terminals and two way communications for transmitting information to an enforcement terminal, including information indicating whether parking in a space has been paid or expired, U.S. Pat. No. 5,343,237 describes for detecting and warning an illegally parked vehicle using television camera images compared to stored television images. U.S. Patent Publication No. 2010/0261465 describes using a mobile phone to interact with various devices including inter alia a parking meter.

### BRIEF SUMMARY OF THE INVENTION

The patents and patent applications used above fall far short of providing an inexpensive, easy to use method of making sure that someone who has parked his or her vehicle in a sign controlled parking spot is informed of parking restrictions. In accordance with the invention, the parking restrictions are provided by an app which generates a display, which can be on the screen of a mobile smartphone, a tablet, a computer, or on a hand-held or vehicle built-in navigation system screen. The app, for example, can obtain parking restrictions for current location from a database that is updated either from a centralized service or by user input. The provided parking restriction information can be used to set reminder alarms when the driver decides to park.

### BRIEF DESCRIPTION OF THE DRAWINGS

For a more complete understanding of the present invention, reference is now made to the following descriptions taken in conjunction with the accompanying drawings, in which:

FIG. 1 is a flow chart showing the operation of the overall invention;

FIG. 2 is a flow chart showing the manner by which a user enters parking restriction information into a database;

FIG. 3 is a flow chart showing the manner by which a user sets preferences and/or controls; and

FIG. 4 is a flow chart showing the manner by which app web services are obtained.

### DETAILED DESCRIPTION OF THE INVENTION

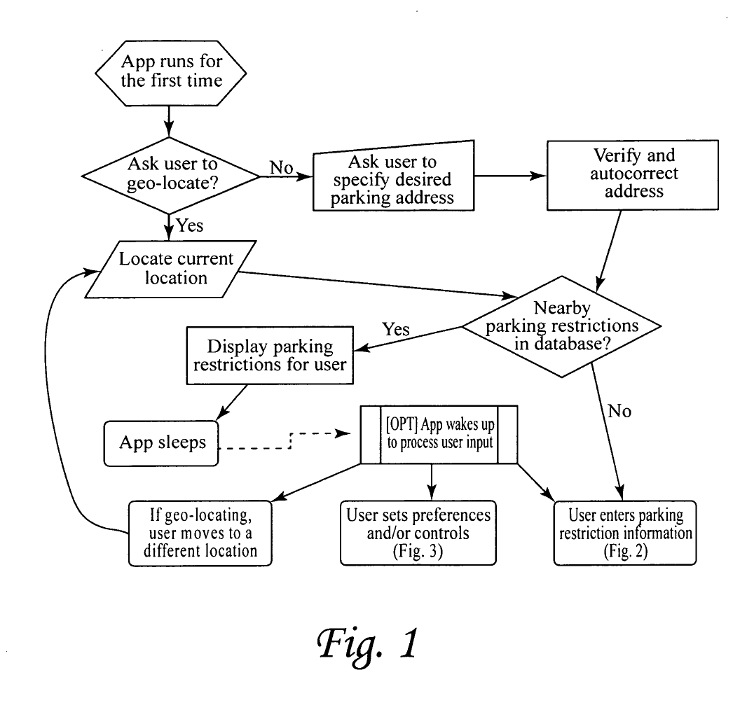

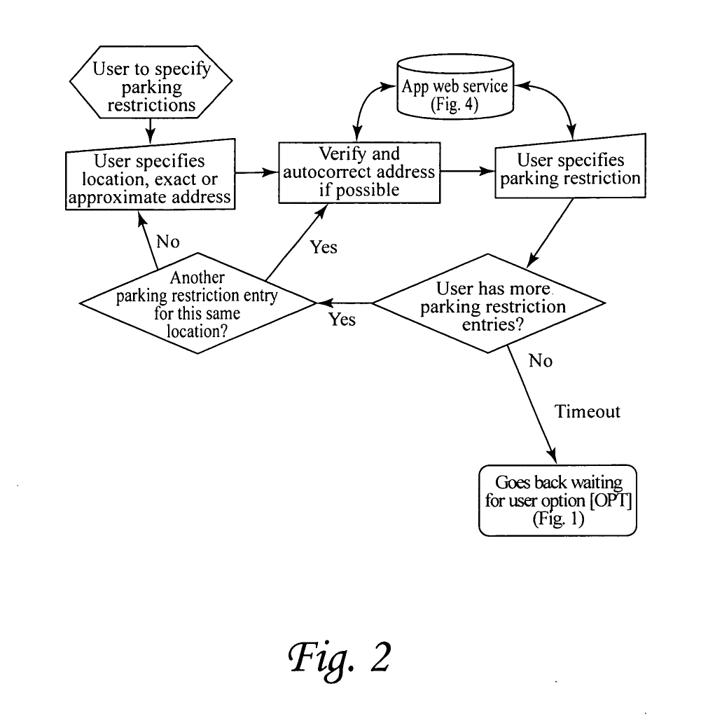

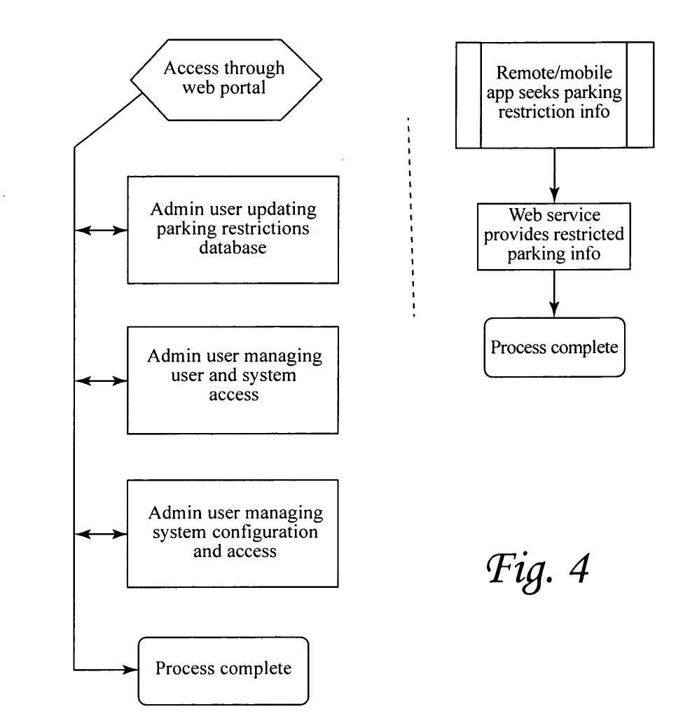

The invention can be implemented on a mobile smartphone by means of an application program (“app”) or by software installed in an automobile, on a hand-held navigation system, on a table, on a laptop computer, or other comparable device, Referring to FIG. 1, a flow chart is shown for the overall operation of the invention. When the app runs for the first time, it asks the user whether to geo-locate, that is, whether to use GPS signals to find the location of the device. If the user answers “no,” then the app asks the user to specify a desired parking address. The app the verifies the address and autocorrects it if necessary, as described with respect to FIGS. 2 and 4, described in more detail below. if when the app asks whether to geo-locate, the user answers “yes,” then the app “looks up” the current parking restrictions from a centralized service using the GPS coordinates for that location.

In either case, if the parking restrictions are not in the centralized database, optionally the app can be set to add the centralized service parking restrictions to the database or can be instructed by the user to do so. The manner by which the user enters the parking restriction information is described in more detail with respect to FIG. 2. This causes the app to wake up from its sleep mode to process the user input.

If the parking restrictions are in the database, then the restrictions are displayed for the user and the app then goes into sleep mode.

If the app is operating in a geo-locating mode and the user moves to a different location, then the app goes back to the step where it looks up the new current location and operates from there as described above.

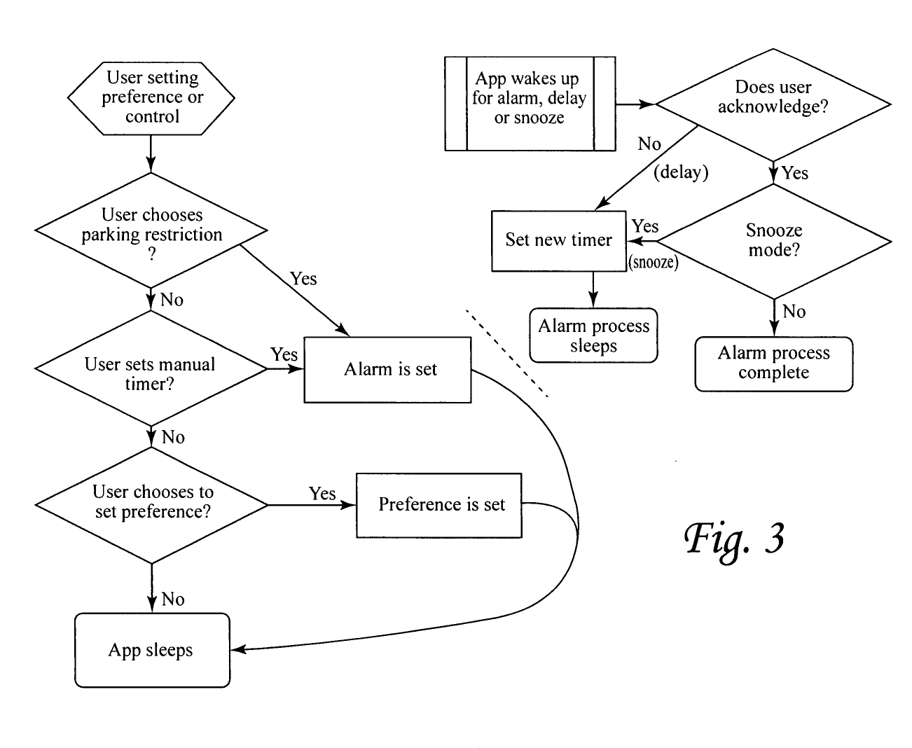

As described in more detail in FIG. 3, the user can set preferences and/or controls, whereupon the app wakes from its sleep mode to process the user input.

The flow chart of FIG. 2 shows the manner by which a user enters parking restriction information into the database. Initially, the user specifies the exact or approximate address. Using the web service described in more detail with respect to FIG. 4, the user specified address is auto-corrected if possible. The app then inquires if the user has more parking restriction entries. If the answer is “Yes” then the app loops back to get another parking restriction If the answer is “No, ” or after a timeout no answer is given, then the app goes back to the [OPT] state of FIG. 1.

Thereafter, the app waits for the user options referred to above with respect to FIG. 1.

Setting of the user's preferences or controls is shown in FIG. 3. Referring to the left side of FIG. 3, the app asks if the user wants to set an alarm using the parking restrictions that have a time element. If the answer is “Yes” then an alarm is set by the app on the user's smartphone, tablet or laptop computer, and the app goes into sleep mode. If the answer is “No” then the app asks if the user wants to set a timer manually. If the answer is “Yes” then the user sets the arm and the app goes into sleep mode. If the answer is “No” then the app asks if the user chooses to set preferences. If the answer is “No” then the app goes into sleep mode. If the answer is “Yes,” then the user can provide input to the app for preferences whereupon the preferences are set, following which the app goes into sleep mode.

Instead of the app sequentially requesting answers to the foregoing questions, the app can simply present a list or lists of the choices for selection by the user.

Referring to the right side of FIG. 3, if the app wakes up to provide an alarm, it asks for acknowledgment by the user. When the user acknowledges the alarm, he or she can indicate whether the app should enter a “snooze” mode.” if the user indicates the “snooze mode,” the app will enter a delay by setting a new timer with a future alarm, after which the app will return to the sleep state. If the user does not indicate the “snooze mode.” The alarm is considered complete, no additional timer is set, and the app returns to the sleep state.

FIG. 4 shows two aspects of the centralized web service that accompanies the app. In one aspect, shown on the left side of FIG. 4, an Administrator (“Admin user” on the flow chart) is able to update the parking restriction database, manage the user and system access, and manage the system configuration and access. In any one session with the centralized web service, the Administrator can do a combination of none, one, or several of each type of management operation.

In another aspect of the centralized web service that accompanies the app, shown on the right side of FIG. 4, the web service provides restricted parking information to any and all instances of the app that make geo-located or other parking restriction lookup requests described with respect to FIG. 2. The web service answers these requests in real time, and replies with respective restricted parking information or that no such information is available. Also, as described earlier, the web service has the ability to add user-specified parking restriction information to its centralized database.

Although the present invention has been described in connection with the preferred embodiments, it is to be understood that modifications and variations may be utilized without departing from the principles and scope of the invention, as those skilled in the art will readily understand.

1. A method for using a device having a display screen, to provide parking restrictions to a user, comprising the steps of:
obtaining parking restriction information for a current location of the user and generating a display of the parking restrictions on the device display screen

2. The method of claim 1 wherein the parking restriction information is obtained from a database

3. The method of claim 2 wherein the database is updated from a centralized service by means of a web service.

4. The method of claim 2 wherein the database is updated by user input.

5. The method of claim 1 wherein the parking restriction information is obtained by means of an app.

6. The method of claim I wherein the device is a mobile smartphone, a tablet, a computer, or a hand-held or vehicle built-in navigation system.

7. The method of claim 1 wherein the parking restriction information is used to set a reminder alarm.

8. A method for using a mobile smartphone, a tablet, a computer, or a hand-held or vehicle built-in navigation system having a display screen, to provide parking restrictions to a user, comprising the steps of:
obtaining parking restriction information by means of an app from a database for a current location of the user and generating a display of the parking restrictions on the device display screen, the database being either is updated from a centralized service by means of a web service or by user input

9. The method of claim 8 wherein the parking restriction information is used to set a reminder alarm when the driver decides to park.
